(19) United States
(12) Patent Application Publication
(10) Pub. No.: US 2004/0187629 A1
(43) Pub. Date: Sep. 30, 2004

(54) Brake pedal and parking brake pedal for which their installation positions have been changed

(76) Inventor: Duke Won Koo, Northbrook, IL (US)

Correspondence Address: DUKE WON KOO, 2050 VALENCIA DRIVE, NORTHBROOK, IL, 60062, US

(21) Appl. No.: 10/820,393

(22) Filed: Apr. 6, 2004

(30) Foreign Application Priority Data
Mar. 11, 2003 (JP) 2003-002058
Oct. 3, 2003 (JP) 2003-272353
Feb. 20, 2004 (KR) 1-1-2004-5029287-

(51) Int. Cl. G05G 1/14

(52) U.S. Cl. 74/560

(57) ABSTRACT

In the conventional arrangement in an automobile, the accelerator pedal and brake pedal are installed close to each other, with the driver using his or her right foot to step on the accelerator pedal and the brake pedal. When the driver must brake suddenly in an urgent situation, he or she may be in a panic, and while intending to step on the brake pedal may step on the accelerator pedal by mistake. This is a crucial shortcoming, leading to major accidents. Changing the installation location of the brake pedal and the parking brake pedal can eliminate this shortcoming. This invention installs the brake pedal to the left of a line drawn perpendicular to, and forward from, the center of the driver's seat. Also, the parking brake pedal is installed between the accelerator pedal and the brake pedal, so as not to interfere with stepping on the accelerator pedal or the brake pedal. Driving technique is also changed, to achieve remarkably safer driving, with the functions of each foot completely divided: the right foot used only to step on the accelerator pedal and the left foot used only to step on the brake pedal.

### CROSS-REFERENCE TO RELATED APPLICATIONS

Not Applicable

### BACKGROUND OF THE INVENTION

This invention relates to the installation location of a brake pedal and a parking brake pedal for a vehicle, especially for an automobile with an automatic transmission.

In the conventional arrangement for an automobile with an automatic transmission, the accelerator pedal, brake pedal, and parking brake pedal are installed in order from right to left, as seen from the driver's seat. The accelerator pedal and brake pedal are installed close to each other, with the driver using his or her right foot to step on the accelerator pedal and the brake pedal. This arrangement has a crucial shortcoming, leading to major accidents. When the driver must brake suddenly in an urgent situation, he or she may be in a panic, and while intending to step on the brake pedal may step on the accelerator pedal by mistake. Many such accidents actually occur.

### BRIEF SUMMARY OF THE INVENTION

This invention provides an installation location for the brake pedal and parking brake pedal, eliminating the above shortcoming, with the brake pedal installed either with at least two-thirds of the total surface area of the brake pedal to the left, or the brake pedal installed entirely to the left, of a line drawn perpendicular to, and forward from, the center of the driver's seat. The parking brake pedal is installed between the accelerator pedal and the brake pedal, so as not to interfere with stepping on the accelerator pedal or the brake pedal. Driving technique is also changed, with the functions of each foot completely divided: the right foot used only to step on the accelerator pedal and the left foot used only to step on the brake pedal. Changing from the conventional arrangement to the new arrangement of this invention can achieve remarkably safer driving.

Characteristic 1

By completely dividing the functions of each foot, with the brake pedal and the accelerator pedal completely separated, and the right foot used only to step on the accelerator pedal and the left foot used only to step on the brake pedal, even when the driver must brake suddenly in an urgent situation, and may be in a panic, the driver will be able to properly step on the brake pedal without error, in the instinctive knowledge that the left foot is for the brake pedal and the right foot is for the accelerator.

Characteristic 2

In order to step on the brake pedal in the conventional arrangement, it takes time to move the right foot from the accelerator pedal position to the brake pedal. In this invention's arrangement, as the left foot is already at the brake pedal position, it takes less time to step on the brake pedal. For example, if the car is traveling at 100 km/h, the time required to step on the brake in this invention's arrangement is from 0.5 to 1.0 seconds less than the conventional arrangement, a distance of 14 to 28 meters. This distance may be enough to enable the driver to avoid a major accident.

### BRIEF DESCRIPTION OF THE SEVERAL VIEWS OF THE DRAWING

FIG. 1 is a plan view showing the invention's arrangement of the brake pedal and parking brake pedal (1).

FIG. 2 is a plan view showing the invention's arrangement of the brake pedal and parking brake pedal (2).

### DETAILED DESCRIPTION OF THE INVENTION

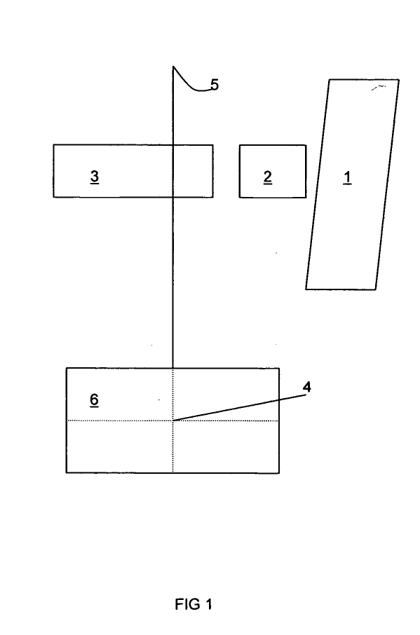

As seen in FIG. 1, in this invention's arrangement, the brake pedal 3 is installed with at least two-thirds of the total surface area of the brake pedal 3 to the left of a line 5 drawn perpendicular to, and forward from, the center 4 of the driver's seat 6. The parking brake pedal 2 is installed between the accelerator pedal 1 and the brake pedal 3, so as not to interfere with stepping on the accelerator pedal 1 or the brake pedal 3.

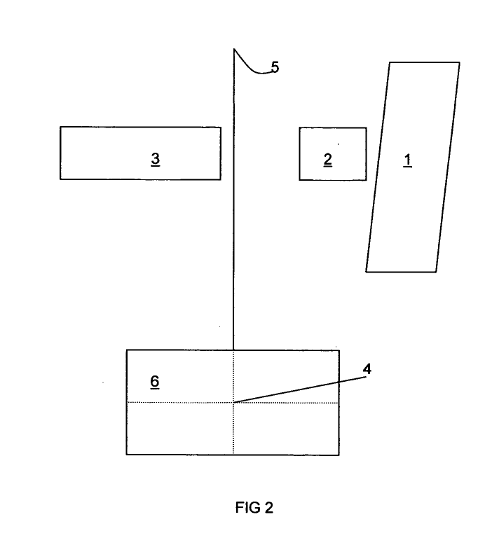

As seen in FIG. 2, in this invention's arrangement, the brake pedal 3 is installed entirely to the left of a line 5 drawn perpendicular to, and forward from, the center 4 of the driver's seat 6. The parking brake pedal 2 is installed between the accelerator pedal 1 and the brake pedal 3, so as not to interfere with stepping on the accelerator pedal 1 or the brake pedal 3.

What is claimed is:

1. For an automobile with an automatic transmission, a brake pedal, comprising:
a brake pedal installed either with at least two-thirds of the total surface area of the brake pedal to the left, or the brake pedal installed entirely to the left, of a line drawn perpendicular to, and forward from, the center of the automobile's driver's seat.

2. For an automobile according to claim 1, wherein the parking brake pedal is installed between the accelerator pedal and the brake pedal.
